(19) United States
(12) Patent Application Publication
(10) Pub. No.: US 2006/0157416 A1
(43) Pub. Date: Jul. 20, 2006

(54) Device for treating water using iron-doped ion exchangers

(76) Inventors: Rudiger Seidel, Sandersdorf (DE); Andreas Schlegel, Krefeld (DE); Reinhold Klipper, Koln (DE); Wolfgang Podszun, Koln (DE); Karl Hans Soest, Koln (DE); Wolfgang Wambach, Koln (DE)

Correspondence Address: LANXESS CORPORATION, 111 RIDC PARK WEST DRIVE, PITTSBURGH, PA, 15275-1112, US

(21) Appl. No.: 11/293,394

(22) Filed: Dec. 2, 2005

(30) Foreign Application Priority Data
Jun. 9, 2004 (WO) PCT/EP04/06229
Jun. 13, 2003 (DE) 103 27 111.2

(51) Int. Cl. C02F 1/42

(52) U.S. Cl. 210/688; 210/282

(57) ABSTRACT

The present invention relates to devices through which a liquid to be treated can flow, preferably filtration units which are used packed with iron-doped ion exchangers for removing heavy metals from aqueous media, and also to methods for production thereof and use thereof.

The invention relates to devices through which can flow a liquid to be treated, preferably filtration units, particularly preferably adsorption containers, in particular filter adsorption containers which are used packed with iron-doped ion exchangers for removing heavy metals, in particular arsenic, from aqueous media, preferably drinking water. The devices can be attached e.g. in the home, to the sanitary and drinking water facilities.

Studies of the National Academy of Science verified in 1999 that arsenic in drinking water causes bladder, lung and skin cancer.

Frequently, one encounters the problem, especially in regions where well water, mains water or generally drinking water is polluted with arsenic or other heavy metals, of not having a suitable drinking water treatment plant in the vicinity or no suitable unit to hand which would continuously remove the pollutants.

Filter cartridges for purifying liquids, preferably contaminated water, which can also contain an adsorption medium, are known in various embodiments.

For separating off solids from natural waters, e.g. membrane filter candles in suitable housings are used.

Brita Wasser-Filter-Systeme GmbH markets cartridges and devices packed with weakly acidic cation exchangers in the hydrogen form. These devices are readily suitable for complete or partial demineralization of drinking water in domestic jugs immediately before use of the drinking water.

DE-A 35 35 677 discloses what are termed cartridges for improving the quality of drinking water which contain ion exchangers and/or activated carbon.

WO 02/066384 A1 discloses a device for chemical/physical water treatment, whereby limescale formation is to be decreased, but which can contain, as water-treating substance, weakly acidic ion-exchange material for the catalytic precipitation of lime.

U.S. Pat. No. 6,197,193 B1 discloses a drinking water filter having inter alia an ion exchanger for removing lead. Other heavy metals such as arsenic or mercury are removed by means of activated carbon.

Usually, the ion exchanger is used together with activated carbon which, however, has the disadvantage that arsenic salts and heavy metal salts as occur in aqueous systems, because of the low adsorption capacity of the activated carbon, are not removed to a sufficient extent, which affects the service life of the cartridges.

The ion-exchange resins used in the prior art have the disadvantage that they bind ions from aqueous solution very unselectively and competing reactions frequently occur in the adsorption. A further disadvantage of ion exchangers according to the abovementioned prior art, is the strong dependence of the adsorption capacity of the ion exchanger on the pH of the water, so that large amounts of chemicals are necessary to set the pH of the water, which is not practicable when the adsorber cartridge is used in the home.

The object was therefore to provide devices through which flow can pass, preferably cartridges having ion exchangers suitable for removing heavy metals, preferably nickel, mercury, lead, arsenic, in particular arsenic, for use, for example in the home, to treat drinking water, which, in addition can be handled and regenerated simply.

“Ion Exchange at the Millennium”, pages 142-149, 2000, discloses loading a porous cation exchanger such as Durolite C-145 with iron ions and its use for the selective adsorption of arsenic V and arsenic III ions. The resin described there adsorbs arsenic selectively as H₂A_{S}O₄^{θ} ion!

JP-A 52-133 890 discloses a method for the selective elimination of arsenic compounds by means of a chelate resin or a cation exchanger, to which transition metals, e.g. iron from iron hydroxide, is adsorbed.

“Reactive & Functional Polymers” 54 (2003) 85-94 discloses the adsorption of arsenic V compounds to iron III-chelated iminodiacetate resins.

The solution of the object and thus subject matter of the present invention are devices, preferably filtration units, in particular cartridges, containing iron-doped ion exchangers and also a method for production thereof and use thereof in devices for water treatment, in particular drinking water treatment, in devices of the food and drinks industries and also in filtration units.

Iron-doped ion exchangers in the context of the present invention are firstly chelate exchangers or cation exchangers which are doped according to the above cited literature reference with iron oxides and/or iron (oxy)hydroxides, or cation exchangers, anion exchangers or chelate exchangers which are loaded using an iron III salt solution. Devices in the context of the present invention are filtration units, preferably cartridges, containers or filters which are suitable for said purpose.

The object also underlying the present invention was to provide a filtration unit for removing arsenic and heavy metals from drinking water, service water, mineral water, garden pond water, agricultural water, holy water and therapeutic water using iron-doped ion exchangers as contact or adsorption/reaction medium, which, owing to the adsorber performance of the packing medium, ensure high removal of the dissolved pollutants, which at the same time withstands the mechanical and hydraulic stresses in the adsorber housings and in addition for safety, prevents by the filtration performance of installed filters the discharge of suspended impurities or abraded ion-exchange particles, possibly loaded with pollutants.

The inventive devices or filtration units or cartridges having the above described iron-doped ion exchangers, their provision, their use and also devices charged with these solve this complex object.

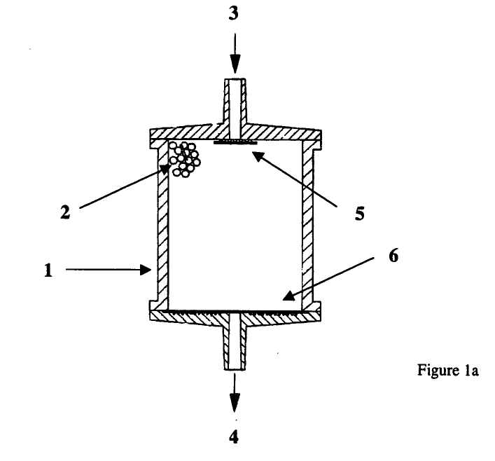

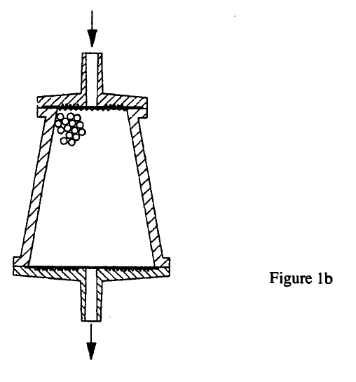

The object is achieved by a device, particularly preferably a filtration unit, which consists of a housing made of plastic, wood, glass, paper, ceramics, metal or a composite material, which is provided with inlet and outlet openings. Exemplary simple embodiments are shown in the diagrams FIG. 1a and FIG. 1b. These housings are described extensively in DE-A 19 816 871. The inlet and outlet openings are separated from the actual housing space which contains a bed of the iron-doped ion exchanger by the covering flat filter plants. The fluid to be treated thus passed sequentially through the first filter layer, the ion exchange particles, the second filter layer and the outlet opening. The housing space can be completely or partially filled with the ion exchanger. The housing space is preferably conical or pyramidal, but can also be cylindrical, spherical, parallelepipedal or helically coiled. By a tapering of the housing space (see diagram FIG. 1b) it is possible to operate the filtration in any desired position and for no bypass to be formed between the bed of the adsorber particles through which the fluid to be filtered can pass unhindered without adsorption. By filling the housing space with a bed of the ion exchanger which occupies between 97 and 99% of the housing volume, a high flow rate of the fluid to be purified is ensured, since, owing to the stability of the ion exchanger, a low resistance opposes the influent liquid.

In preferred embodiments of the invention, the housing space is formed in the tapering sections as truncated cone or truncated pyramid.

For the flat filter layers, depending on the field of application, various materials are indicated, e.g. in DE-A 19 816 871.

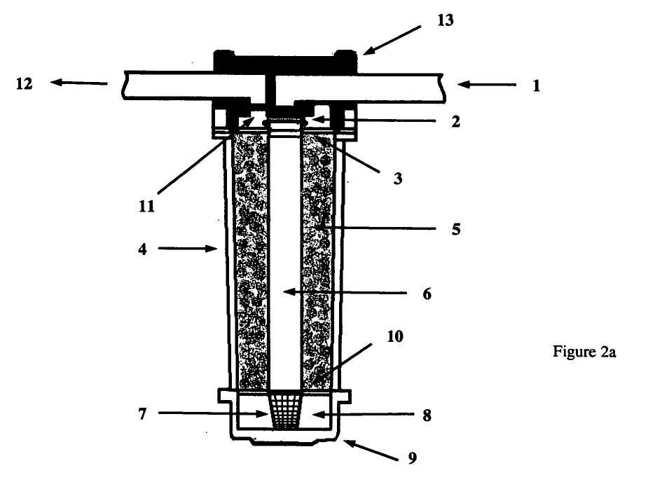

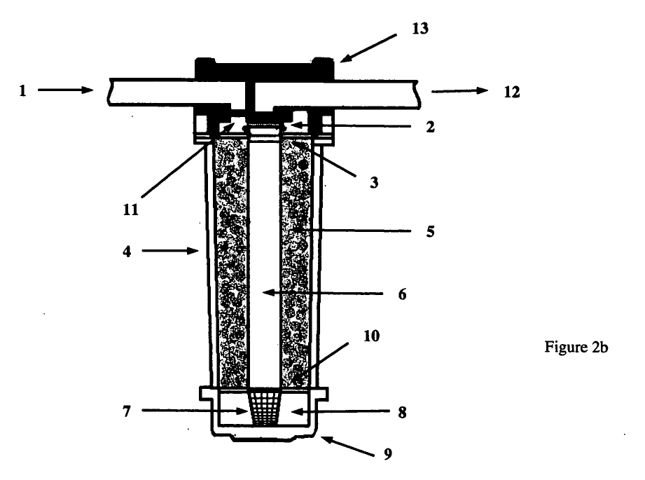

An improved embodiment of an adsorber tank to be used according to the invention which is also suitable for the regeneration is shown in diagram FIG. 2a and FIG. 2b. They each show the domestic filter module in longitudinal section.

The adsorber housing (4) having the iron-doped ion exchanger (5) having filter plates arranged at the end at the top (3) and bottom (10) and a centrally arranged inlet tube (6) can be isolated as a unit by a threaded joint having the lid (13) at the top end and a threaded joint having the bottom attachment (9) at the bottom end by undoing the threaded joints. If the cartridge is loaded, a new one can be inserted and a bottom plate and cover plate cleaned. At the top end, the inlet tube (6) is firmly fixed during use to the inlet port (2) via a suitable sealing ring. The inlet tube can be removed from the cartridge housing and inserted into a new fresh cartridge housing. Through this, the incoming liquid flows directly onto a sieve basket (7) which prefilters suspended matter, algae and the like and retains these at the inlet into the actual ion-exchange cartridge, so that the ion-exchange material does not clump or stick together. The sieve (7) serves for uniform distribution of the incoming liquid stream into the bottom space and is therefore preferably conical, i.e. truncated conical and completely encloses the inlet tube. It is not only fixed to the inlet tube, but also to the filter plate (10) surrounding it via loose sealing rings. The fabric of the sieve can consist of customary fine-mesh filter materials, e.g. of plastic, natural material or metal.

The screwed-in bottom part (9) can additionally comprise a suitable filter material or filter web (8) which can be selected according to the type and amount of the suspended matter to be expected. In the case of large amounts of solid foreign materials, the sieve (7) and the filter web (8) can readily be removed and cleaned by unscrewing the bottom part. The filter plate (10) which can consist of fine-pored ceramic, separates the bottom space (9) from the contact space having the iron-doped ion exchangers (5) so that no ion-exchange material passes into the bottom space and no prefiltered material passes into the contact space. By the water to be purified passing through the contact space having the iron-doped ion exchanger ascending from bottom to top, the pollutants to be removed are removed by physisorption and/or chemisorption to the ion-exchange material. An additional filter plate at the top end of the cartridge housing ensures that no ion exchanger passes into the outlet (12). Owing to elevated water pressure or long service time of the device, a fine fraction can abrade from the ion exchanger which passes through the filter plate (3). To avoid this (pollutant-loaded) fine fraction from passing into the outlet, in the interior of the lid (13), filter material or filter web (11) is embedded, which retains the fine fraction.

The filter layers (3) and (10) also serve for uniformly distributing the fluid onto the adsorber space (5) and collecting again after exit from this. The clean water purified from foreign matter and pollutants leaves the device via the outlet port (12).

The lid (13) can additionally have a valve in order to permit gases (e.g. air present in the cartridge housing) entrained in the operation to escape on first operation.

Depending on the application, it can be advantageous to operate the device just described in reverse sequence (FIG. 2b). That means that the water to be purified then enters from the inlet port (1) directly onto the prefilter (11) which retains the suspended matter and foreign bodies, then passes through the filter plate (3), enters into the contact space, where the dissolved pollutants adsorb to the ion-exchange material, passes via the cartridge bottom plate (10) into the bottom space (9) where any filter material (8) is embedded, in order to retain abraded ion-exchange material, the sieve basket (7) performing additional filtration service, so that the purified water, via the outlet tube (6) and the outlet port, leaves the device via the opening (1).

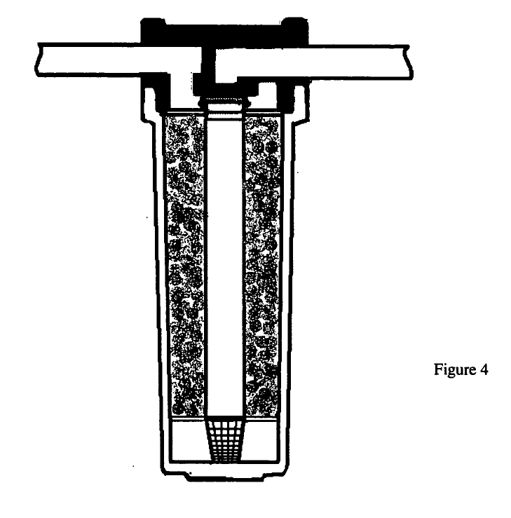

A simpler embodiment which operates, however, according to the same principle as described above is shown in FIG. 4. It shows a device which contains the iron-doped ion exchanger and in which the device itself forms a unit.

In principle, of course, other embodiments and designs are possible which are similar to the described structures and operate in the manner described, i.e. contain an inlet and outlet opening for waters and iron-doped ion exchangers.

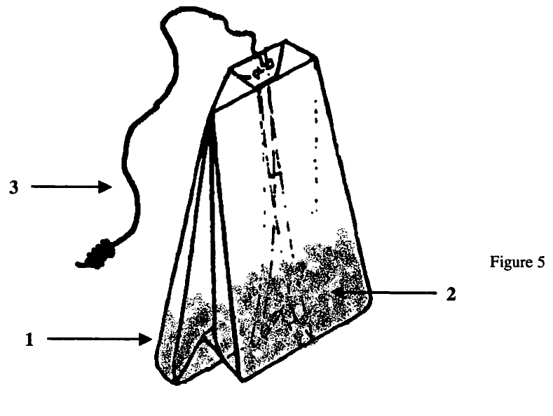

The diagram FIG. 5 shows a filter bag which, filled with iron-doped ion exchangers, can be fed to a water to be purified in order to remove the pollutants present therein by adsorption.

Filter bags and extraction sleeves are known, e.g. in varied forms and designs for providing hot infused drinks, in particular tea. DE-A 839 405 describes, e.g. such a folded bag as is used for preparing tea and the like. By a special folding technique which forms a double-chamber system, an intensive mixing of the eluent with the substance to be extracted is ensured.

Conversely, iron-doped ion exchangers may also be embedded into semi-permeable bags or pockets having filter action (for example the above described folding bags) and these packages may be fed to the natural water to be purified in order thereby, after a certain contact time, to remove the pollutants from the water by adsorption to the adsorbent material (see diagram FIG. 5). The iron-doped ion exchangers firstly withstand the mechanical and hydraulic stresses in the filter bag, and secondly, owing to the filter performance of the filter membrane, escape of any fine fraction formed by abrasion of the adsorption medium into the water to be purified is prevented.

The various embodiments of the present invention share the fact that iron-doped ion exchangers may be embedded in the housings having filter action and the liquid to be purified may flow through the filter housing, or the filter package is fed to the liquid to be purified and thus ensures adsorption of the pollutants.

The production of iron-doped ion exchangers is known from the above-cited literature, in addition, however, other production methods are also conceivable.

For the iron doping, strongly acidic or weakly acidic cation exchangers, strongly basic or weakly basic anion exchangers, or chelate resins are suitable. These can be gel-type or macroporous ion exchangers, the macroporous types being preferred. The particle size of the iron-doped ion exchangers is in the range from 100 to 2000 μm, preferably 200 to 1000 μm. The particle size distribution can be heterodisperse or monodisperse.

Particularly highly suitable for the iron loading are the Lewatit®TP 207 and Lewatit® TP 208 macroporous cation exchangers having iminodiacetic acid groups and also the Lewatit® SP 112 and Lewatit® Mono Plus SP112 macroporous strongly acidic cation exchangers.

For example, in Roer et al. “Reactive & Functional Polymers” 54 (2003) 85-94 a Lewatit® TP 207 macroporous cation exchanger from Bayer having chelating iminodiacetic acid groups is used. This is first air-dried and sieved into fractions having a particle size of less than 0.5 mm. After washing with demineralized water, the resin is converted into the acidic form by means of 0.1 molar HCl. Thereafter it is transferred into a column, again washed to pH=5 using demineralized water and finally set to pH 2.5 by HCl.

The loading with Fe III ions is performed in glass columns and is carried out batchwise using 0.1 molar Fe³⁺ solution (FeCl₃•6 H₂O; pH 2.0). This is performed until the Fe³⁺ concentration of the effluent from the column corresponds to that of the feed.

To load resins having a relatively low capacity with iron, reference is made to the instructions in “Reactive & Functional Polymers 54” (2003) page 87.

In view of a particularly good adsorption of As(V), the Fe(III) ions of the doped ion exchanger can be converted into hydrated iron oxide by reaction with lyes.

For instance, in Sengupta et al., “Ion Exchange at the Millennium”, 142-149 (2000), a hybridsorbent of a spherical macroporous cation exchanger using submicron hydrated iron oxide (HFO) particles is produced by:

Stage 1

Loading the porous cation exchanger in acidic medium with Fe III on the sulfonic acid functionalities.

Stage 2

Desorption of Fe III and simultaneous precipitation of Fe III hydroxide within the pores of the ion exchanger

Stage 3

Washing the resin with ethanol and gentle heat treatment to convert partially amorphous iron hydroxide into crystalline geothite and haematite.

This process achieves a loading of the ion exchanger with virtually 12% by weight of Fe. For example, Puralite C-145 is used as ion exchanger.

The finely divided iron oxide and/or iron (oxy)hydroxide used has a particle size of up to 500 nm, preferably up to 100 nm, particularly preferably 4 to 50 nm, and a BET surface area of 50 to 500 m²/g, preferably 80 to 200 m²/g.

The primary particle size was determined from scanning electron microscope images, e.g. at an enlargement of 60 000:1 by measurement (instrument: XL 30 ESEM FEG, Philips). If the primary particles are needle shaped, e.g. in the α-FeOOH phase, the needle width may be reported as an index of the particle size. In the case of nanoparticulate α-FeOOH particles, needle widths of up to 100 nm are observed, but chiefly between 4 and 50 nm. α-FeOOH primary particles usually have a length:width radio of 5:1 up to 50:1, typically from 5:1 to 20:1. By doping or special reaction procedure, the needle shapes, however, may be varied in their length:width ratio. If the primary particles are isometric, e.g. in the α-Fe₂OH₃, γ-Fe₂OH₃, Fe₃OH₄ phases, the particle diameters can absolutely also be smaller than 20 nm.

By mixing nanoparticulate iron oxides or iron (oxy)hydroxides with pigments and/or Fe(OH)₃, on the scanning electron micrographs, the occurrence of the given pigment or seed particles are recognized in their known particle morphology which are held together or stuck to one another by the nanoparticulate seed particles or the amorphous Fe(OH)₃ polymer.

In JP 52-133 890 example 2, the loading of 7 ml of a strongly acidic cation exchanger in the H form with 300 ml of 0.05 molar aqueous iron nitrate solution (pH 3) at 200 ml/hour is described. Finally, the resin is washed with 100 ml of pure water. In example 3, correspondingly 7 ml of a chelate resin are loaded in the sodium form ((Dowex® A-1, Unitika UR 10, 30-50 mesh).

The iron-doped ion exchangers in filtration units, for example cartridges, are used according to the invention in the purification of liquids, in particular for removing heavy metals. A preferred use in this technical field is the decontamination of water, in particular of drinking water. Very recently, particular attention is being paid to the removal of arsenic from drinking water. The inventive iron-doped ion exchangers are outstandingly suitable for this, since even the low limit values established by the US authority EPA can not only be maintained, but even undershot by using the inventive devices having iron-doped ion exchangers.

For this, the iron-doped ion exchangers can be used in conventional devices as are already used, e.g. charged with activated carbon, for removing pollutants of other types. A batch operation, for example in cisterns or similar containers, which if appropriate are equipped with stirrers, is actually possible but use in continuously operated plants such as through-flow adsorbers is preferred.

Since raw water to be treated to give drinking water customarily also contains organic impurities such as algae and similar organisms, the surface of ion exchangers is coated during use with generally slimy deposits which impede or even prevent the ingress of water and thus the adsorption of constituents to be removed. For this reason, the filtration units are backwashed with water from time to time, which is preferably carried out at times of low water consumption on individual devices taken out of operation. In this operation the resin is swirled up and as a result of the associated mechanical stress of the surface, the unwanted deposit is removed and discharged against the direction of flow in use. The wash water is customarily fed to a sewage treatment plant. In this case the inventive iron-doped ion exchangers prove very particularly useful, since their high strength makes possible cleaning in a short time, without significant losses of ion-exchange material being recorded, or the backwash water recycled to the waste water being highly polluted with heavy metals.

By means of a suitable prefilter and postfilter, the contaminants which could plug the filtration unit are retained.

The material abrasion is minimized by the stability of the ion exchangers and by suitable packing of the same.

Since the iron-doped ion exchangers are free from foreign binders, the material after use is relatively simple to dispose of; however, it can also be regenerated. For instance, the adsorbed arsenic can be removed chemically, e.g. by treatment with concentrated sodium hydroxide solution, and the ion exchanger is recovered as a clean material which can either be recycled for the purpose of the same application, or incinerated. Depending on application and legal provisions, the ion exchanger which is polluted with heavy metals and exhausted can be fed to a use when the heavy metals withdrawn from the drinking water are permanently immobilized in this manner and removed from the water cycle.

### EXAMPLES

### Example 1

Purolite C-145, a macroporous cation exchanger, is produced as in Sengupta et al., Ion Exchange at the Millennium, 142-149 (2000) by means of submicron hydrated iron oxide particles by, in a first stage, charging the cation exchanger in an acidic medium with iron III ions on the sulfonic acid functionalities. In a second stage, the desorption of Fe III and simultaneous precipitation of Fe III hydroxide within the pores of the ion exchanger is carried out, and in a third stage, the resin is washed with ethanol and treated with gentle heat.

The resin is charged at 11.6% Fe.

This resin is packed into a device according to FIG. 2a and flushed with an aqueous solution which contains 280 ppb of arsenic ions. The arsenic is bound to the resin as H₂AsO₄^{θ}.

On exit, the aqueous solution contains 5 ppb of arsenic, i.e. the arsenic was virtually quantitatively removed from the aqueous solution.

### Example 2

Lewatit®TP 207, a macroporous cation exchanger functionalized by chelating iminodiacetic acid groups having a particle size <0.5 mm is converted into the acid form by means of 0.1 molar HCl and packed into a glass column. In this the resin is first washed to pH=5 by deionized water and finally set to pH=2.5 by HCl. Then, from the top a 0.1 molar Fe³⁺ solution (FeCl₃•6 H₂O; pH 2.0) is added in portions onto the resin. This is performed until the same concentration of Fe³⁺ ions is also measured in the effluent. The resin is then doped with Fe ions.

This resin doped with Fe³⁺ ions is charged into a device according to FIG. 4.

### Example 3

Production of an ion exchanger doped with iron oxide/iron oxyhydroxide

400 ml of Lewatit®TP207 are admixed with 750 ml of aqueous iron (III) chloride solution which contains 103.5 g of iron (III) chloride per liter and 750 ml of deionized water, and stirred for 2.5 hours at room temperature. Then, a pH of 6 is set using 10% strength by weight sodium hydroxide solution, and maintained for 20 h.

Thereafter, the ion exchanger is filtered off over a sieve and washed with deionized water until the effluent is clear.

Resin yield: 380 ml

The Fe content of the loaded ion exchanger beads was determined as 14.4%. As crystalline phase, α-FeOOH may be identified from powder diffractograms.

### Example 4

Testing the iron-doped ion exchanger from Example 3.

In a cylindrical filtration unit which has a diameter of 2.2 cm and a height of 13 cm and the bottom of which consists of a G0 frit having a pore width of 160-200 μm, 50 ml of iron-doped ion exchanger from example 3 are charged. Water which has a content of 100 μg/l of As(V) as disodiumhydrogenarsenate is passed through this filter unit at different flow rates, in each case for 30 min and the respective arsenic content was determined in the effluent by elemental analysis.

| | Arsenic content | Arsenic content |
|---|---|---|
| Flow rate | in the feed | in the effluent |
| 25 bed volumes/h | 100 μg/l | >1 μg/l |
| 50 bed volumes/h | 100 μg/l | >1 μg/l |
| 75 bed volumes/h | 100 μg/l | 1 μg/l |
| 100 bed volumes/h | 100 μg/l | 1 μg/l |

In addition, 100 ml of the effluent of the experiment are filtered through a microfilter having a pore size of 0.5 μm at a flow rate of 100 bed volumes/h. No residues were detectable on the filter.

### Example 5 (Comparative Example)

In the above described cylindrical filtration unit, 50 ml of a mixture of non-doped chelate resin Lewatit®TP207 and iron oxyhydroxide (α-FeOOH according to Example 2 of US 2002/0074292) are charged. The mixing ratio is chosen in such a manner that the mixture has an iron content of 14.4% iron. This is the same iron content as in Example 4. Water which has a content of 100 μg/l of As(V) as disodiumhydrogenarsenate is passed through this filter unit at different flow rates, again in each case for 30 min. and the respective arsenic content is determined in the effluent by elemental analysis.

| | Arsenic content | Arsenic content |
|---|---|---|
| Flow rate | in the feed | in the effluent |
| 25 bed volumes/h | 100 μg/l | 11 μg/l |
| 50 bed volumes/h | 100 μg/l | 19 μg/l |
| 75 bed volumes/h | 100 μg/l | 20 μg/l |
| 100 bed volumes/h | 100 μg/l | 29 μg/l |

In addition, 100 ml of the effluent of the experiment are filtered through a microfilter having a pore size of 0.5 μm at a flow rate of 100 bed volumes/h. A residue of approximately 10 mg is determined, which predominantly consists of FeOOH. This residue is dissolved in hydrochloric acid and analyzed for arsenic. 18 μg of arsenic were found. It is apparent that in the filtration unit, under the selected conditions, finely divided iron oxyhydroxide, which contains measurable amounts of arsenic, is released to the water which is to be purified.

FIG. 1a: adsorber tank with iron-doped ion exchanger

FIG. 1b: adsorber tank with tapering, with iron-doped ion exchanger

Legend for FIGS. 1a and 1b:
1) device housing
2) iron-doped ion exchanger
3) inlet port
4) outlet port
5) first flat filter layer having fluid distribution channels
6) second flat filter layer having fluid collection channels

FIG. 2a: device having iron-doped ion exchanger-containing cartridge and housing

FIG. 2b: reverse operation of the device (see FIG. 2a)

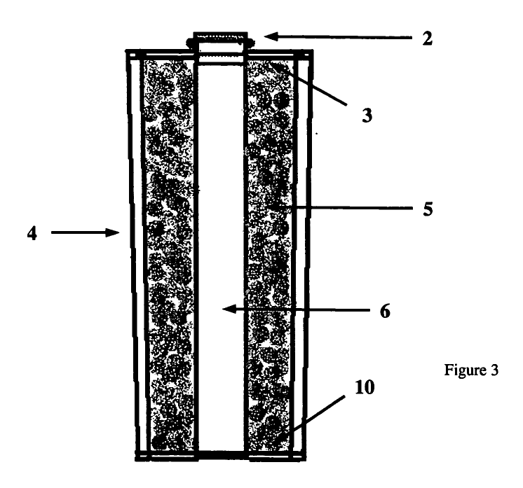

FIG. 3: filter cartridge housing having iron-doped ion exchanger

Legend to FIGS. 2a, 2b, 3:
1) inlet or outlet tube
2) sealing ring
3) filter plate
4) ion-exchange cartridge housing
5) contact space having iron-doped ion exchanger
6) inlet tube
7) sieve basket
8) prefilter or postfilter
9) bottom part
10) filter plate
11) post filter or prefilter
12) outlet tube or inlet tube

FIG. 4: adsorber tank having iron-doped ion exchanger

FIG. 5: pocket filter having iron-doped ion exchanger

Legend to FIG. 5:
1) filter bag
2) iron oxide-doped ion exchanger
3) suspension

1. A filtration unit through which media can flow for removing pollutants from fluids, characterized in that the device contains a bed of iron-doped ion exchangers.

2. The filtration unit as claimed in claim 1, characterized in that the ion exchangers are doped with iron oxide and/or iron (oxy)hydroxide or by means of an iron III salt solution.

3. The filtration unit for removing pollutants from fluids as claimed in claim 1, characterized in that it consists of a cartridge housing in the container of which are mounted a centered inlet tube, flat filter layers opposite the end side, a lid which ensures the feed and outlet of the fluid to be purified, and also a bottom part.

4. The filtration unit as claimed in claim 1, characterized in that the iron-doped ion exchanger is either a macroporous cation exchanger functionalized by sulfonic acid groups or a cation exchanger functionalized by chelating iminodiacetic acid groups which is doped with iron.

5. The filtration unit as claimed in claim 4, characterized in that use is made of an iron-doped ion exchanger based on Purolite C-145, Lewatit® SP 112, Lewatit®TP 207 or Lewatit® TP 208.

6. The filtration unit as claimed in claims 1 to 5, characterized in that the fluid is contaminated water.

7. A method for the adsorption of nickel, mercury, lead and arsenic from aqueous media, characterized in that a filtration unit as claimed in claim 1 is used.

8. The use of the filtration unit as claimed in claim 1 for the adsorption of nickel, mercury, lead and arsenic, preferably arsenic, from aqueous media.
